(19) United States
(12) Patent Application Publication
(10) Pub. No.: US 2009/0041005 A1
(43) Pub. Date: Feb. 12, 2009

(54) Method for activating an internet telephony hardware device

(76) Inventor: David Zong Chen, Hong Kong (HK)

Correspondence Address: KAUTH , POMEROY , PECK & BAILEY ,LLP, P.O. BOX 19152, IRVINE, CA, 92623, US

(21) Appl. No.: 11/891,093

(22) Filed: Aug. 8, 2007

(51) Int. Cl. H04L 12/56

(52) U.S. Cl. 370/352

(57) ABSTRACT

Systems and methods for activating an Internet telephony hardware device that is pre-configured with connection information are described. One embodiment of the method of the invention for activating an Internet telephony hardware device (40) for use with a predetermined Internet telephony service provider (30), the Internet telephony hardware device (40) being pre-configured with connection information (41) for connecting to the predetermined Internet telephony service provider (30), includes obtaining (101) an activation number, connecting (103) the Internet telephony hardware device (40) to the Internet and dialing (104) the activation number using the Internet telephony hardware device (40) to activate the Internet telephony hardware device (40) for use with the predetermined Internet telephony service provider (30).

### TECHNICAL FIELD

The invention relates generally to methods for activating Internet telephony hardware devices for use with a predetermined Internet telephony service provider and more specifically to activation of an Internet telephony hardware device pre-configured with connection information for connecting to the predetermined Internet telephony service provider.

### BACKGROUND OF THE INVENTION

Use of Voice over IP (VoIP) technology for telephony is gaining popularity as it provides a free or low cost way to call anybody. It is especially beneficial as a replacement for long distance calls where conventional fixed line IDD rates are expensive.

Many Internet telephony service providers provide a softphone (software for making telephone calls using a computer) and also allow users to use a VoIP phone to make calls removing the need for a computer.

VoIP phones have detailed installation instructions and typically require someone with some computer skills to configure the VoIP phone to be used with a particular service provider. Therefore, VoIP phones can be difficult and time consuming to set up by ordinary people which have lead to low rates of adoption.

### SUMMARY OF THE INVENTION

One embodiment of the invention involves activation of an Internet telephony hardware device for use with a predetermined Internet telephony service provider, where the Internet telephony hardware device being pre-configured with connection information for connecting to the predetermined Internet telephony service provider, and includes obtaining an activation number, connecting the Internet telephony hardware device to the Internet and dialing the activation number using the Internet telephony hardware device to activate the Internet telephony hardware device for use with the predetermined Internet telephony service provider.

A further embodiment includes performing a lookup on a database after the activation number is dialed, to match a Session Initiation Protocol (SIP) number of the Internet telephony hardware device with the activation number for authenticating the Internet telephony hardware device for use with the predetermined Internet telephony service provider.

In another embodiment, the connection information includes SIP number, password, SIP proxy server address, port forwarding details, IP filters, IP address, subnet mask, local domain name, Virtual Private Network (VPN) pass-through, Point-to-Point Protocol over Ethernet (PPPoE) settings and Dynamic Host Configuration Protocol (DHCP) settings.

In a still further embodiment, the activation number may be a Dialed Number Identification Service (DNIS) number.

In still another embodiment, the Internet telephony hardware device may be a Voice over IP (VoIP) telephone or an Analog Telephone Adaptor (ATA).

A yet further embodiment also includes the registering an account with the predetermined Internet telephony service provider to obtain the activation number. In several embodiments, the user may register with the predetermined Internet telephony service provider via a web page.

In yet another embodiment, each Internet telephony hardware device is pre-configured with connection information for the predetermined Internet telephony service provider by inputting connection information for a plurality of Internet telephony hardware device into an electronic file by the predetermined Internet telephony service provider, providing the electronic file to another party, and writing data including the connection information for each Internet telephony hardware device provided in the electronic file into firmware of each Internet telephony hardware device by the other party.

A further embodiment again also includes incrementally reading the data from the electronic file for each Internet telephony hardware device by the other party, and automatically writing the data into firmware of each Internet telephony hardware device.

In another embodiment again, the writing of the data into firmware of each Internet telephony hardware device by the other party may be performed by manual data entry.

In a further additional embodiment, the other party may be a manufacturer of the Internet telephony hardware device.

Another additional embodiment includes an activation module to obtain an activation number and a dial pad provided by the Internet telephony hardware device to dial the activation number when the Internet telephony hardware device is connected to the Internet to activate the Internet telephony hardware device for use with the predetermined Internet telephony service provider.

A still yet further embodiment includes pre-configured connection information for connecting to a predetermined Internet telephony service provider. In addition, an activation number is dialed by the Internet telephony hardware device to activate the Internet telephony hardware device for use with the predetermined Internet telephony service provider.

### BRIEF DESCRIPTION OF THE DRAWINGS

An example of the invention will now be described with reference to the accompanying drawings, in which:

FIG. 1 is a process flow diagram for activating an Internet telephony hardware device in accordance with a preferred embodiment of the present invention;

FIG. 2 is a screen shot of a first web page during the process of FIG. 1;

FIG. 3 is a screen shot of a second web page during the process of FIG. 1;

FIG. 4 is a screen shot of a third web page during the process of FIG. 1;

FIG. 5 is a screen shot of a fourth web page during the process of FIG. 1;

FIG. 6 is a screen shot of a fifth web page during the process of FIG. 1; and

FIG. 7 is a screen shot of a sixth web page during the process of FIG. 1.

### DETAILED DESCRIPTION OF THE DRAWINGS

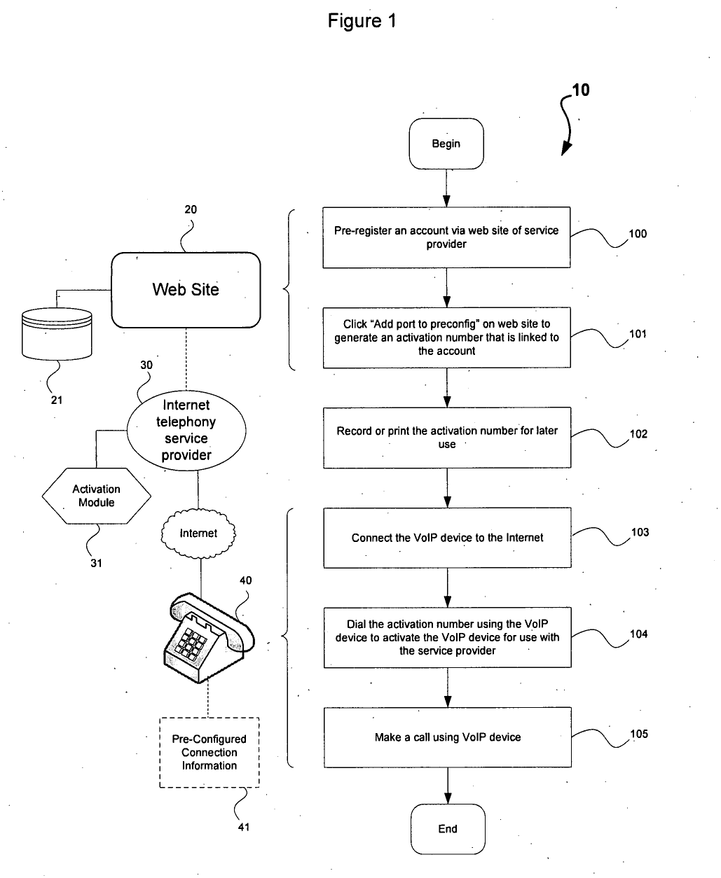

Referring to FIG. 1, a method 10 for activating an Internet telephony hardware device 40 for use with a predetermined Internet telephony service provider 30 is provided. The device 40 is pre-configured with connection information 41 for connecting to the predetermined Internet telephony service provider 30. Connection information 41 can include: SIP number, password, SIP proxy server address, port forwarding details, IP filters, IP address, subnet mask, local domain name, Virtual Private Network (VPN) pass-through, Point-to-Point Protocol over Ethernet (PPPoE) settings and/or Dynamic Host Configuration Protocol (DHCP) settings. In other embodiments, other information appropriate to the activation of a particular Internet telephony hardware device can be included as connection information pre-configured within the Internet telephony hardware device. A user is required to pre-register an account via the web site 20 of the service provider 30. An activation number is generated and obtained by the user 101. The activation number may be printed or recorded as it is required for later use 102. Next, the device 40 is connected to the Internet if not previously connected 103. Next, the activation number is dialed 104 using the device 40 to activate the device 40 for use with the predetermined Internet telephony service provider 30. After the device 40 has been activated, a VoIP call may be made immediately 105.

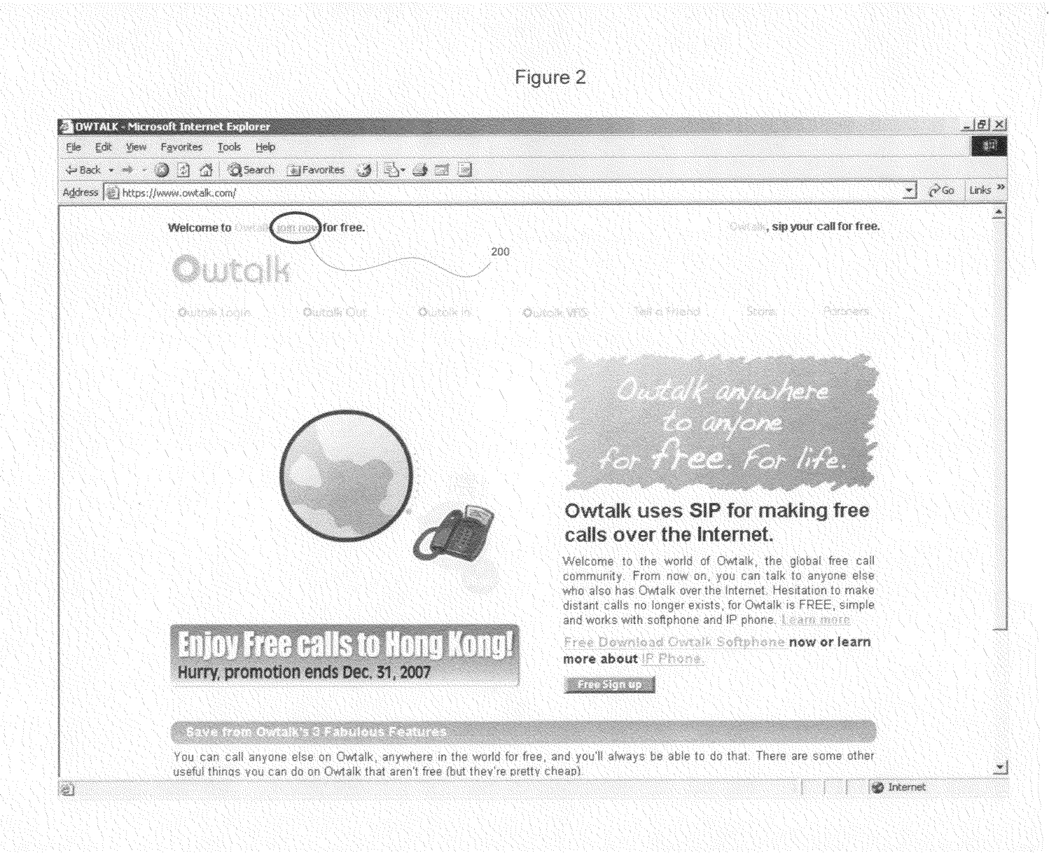

Referring to FIG. 2, a user clicks on the “join now” link 200 on the main page of the web site 20 of the service provider 30. This will initiate the user registration process in order to obtain an activation number.

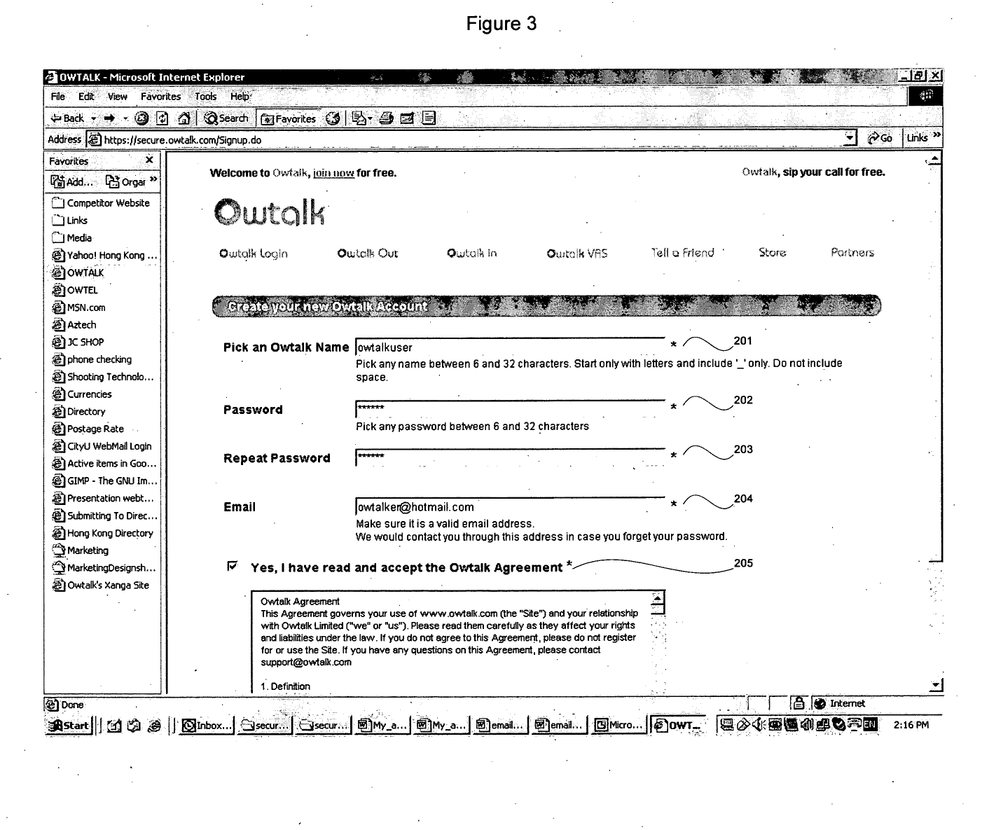

Referring to FIG. 3, the user completes a web based form to input their account details. A username is entered 201. Then, a password 202 is chosen. The password must be repeated 203 to avoid any typing mistakes. The user enters their e-mail address so that the service provider is able to contact the user 204, and verify the user with a confirmation code sent to their e-mail address. The Terms of Use and Agreement must be acknowledged by the user before being allowed to move to the next page 205.

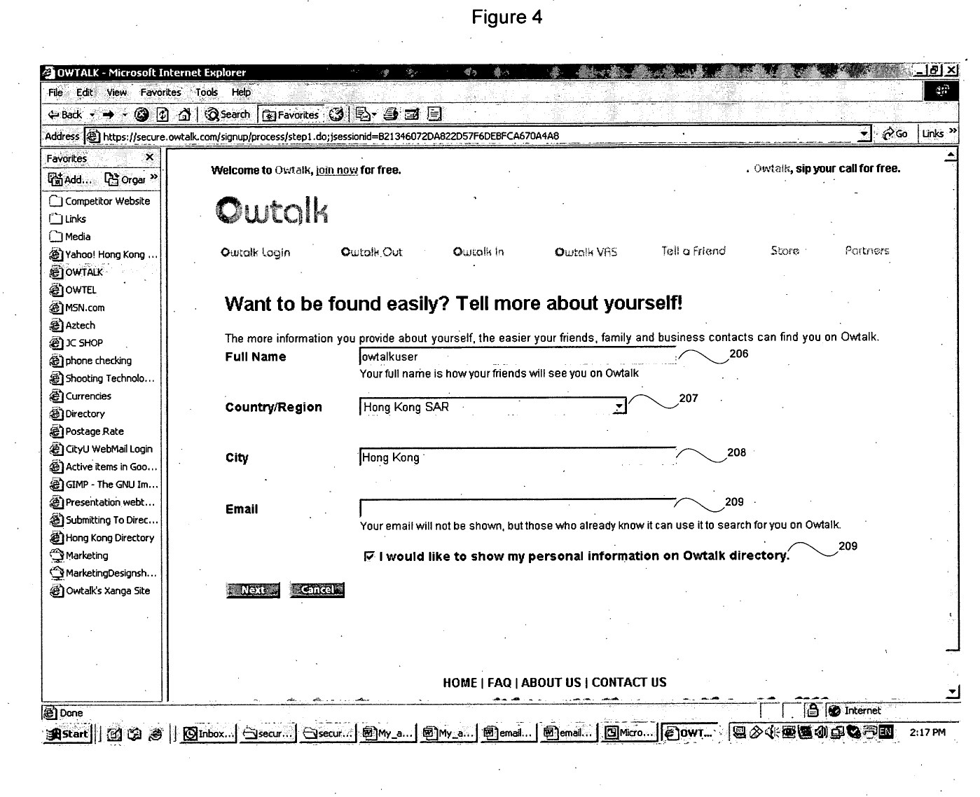

Referring to FIG. 4, the next screen presented to the user is to input details so that they may be easily found by other people who need to contact them: Their full name is entered 206. Then, their location is selected 207 and their city is entered 208. They may also choose to list their e-mail address 209 as a searchable item which is not displayed for privacy reasons. Also, the user may click a checkbox 209 which indicates they would like to show their personal information on a user directory of the service provider 30.

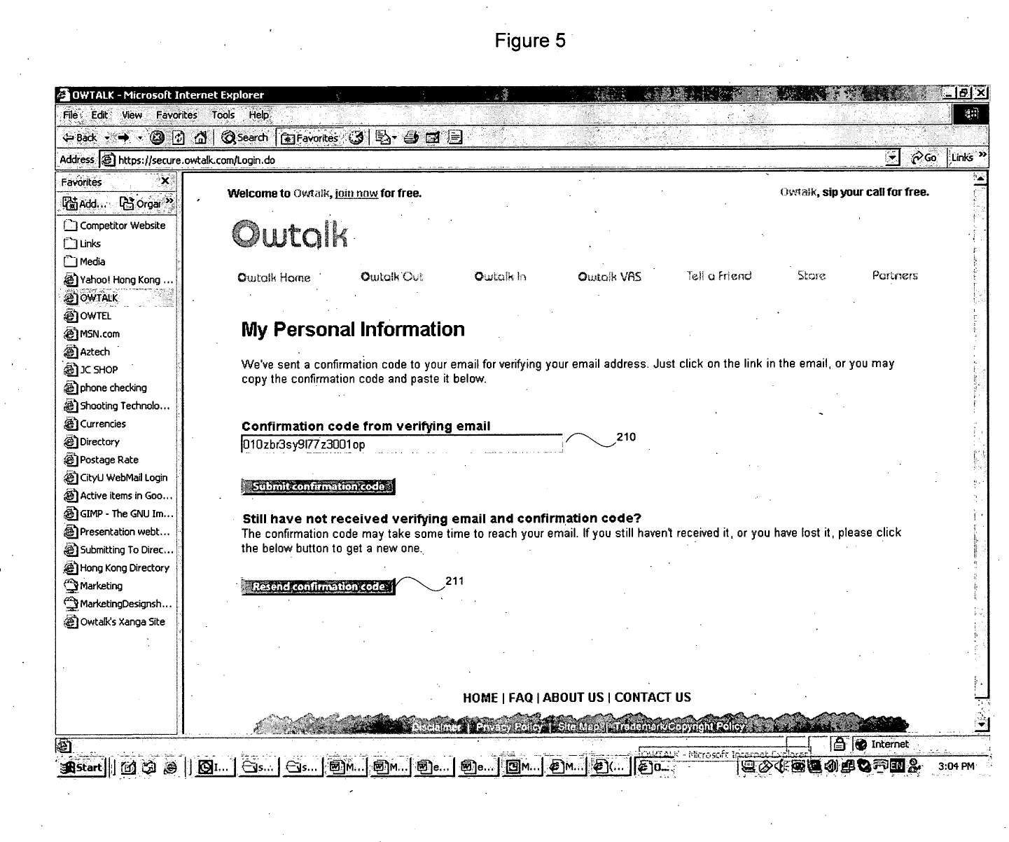

Referring to FIG. 5, the user must enter the confirmation code that was sent to their e-mail address that was entered on the web page at FIG. 3. This is to verify the user's email address is authentic.

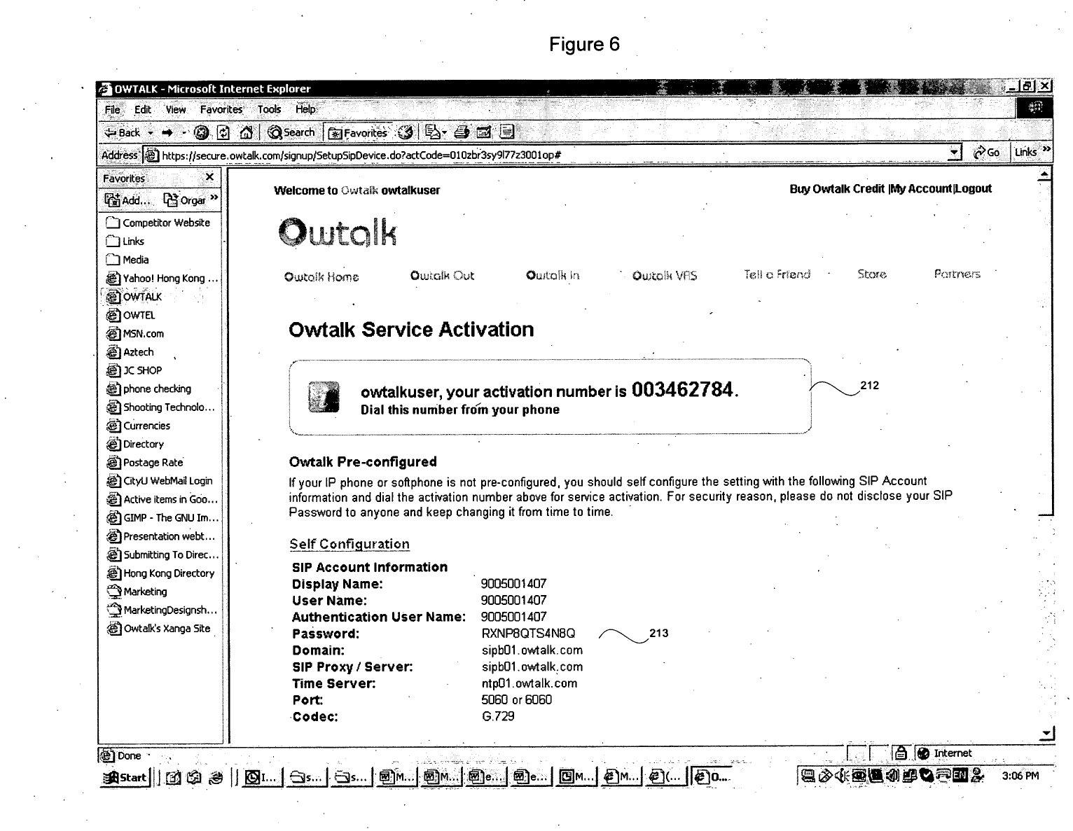

Referring to FIG. 6, the activation number is generated by the service provider 30 and displayed to the user in the top display box 212. The configuration details associated with the activation number are displayed in the bottom display box 213.

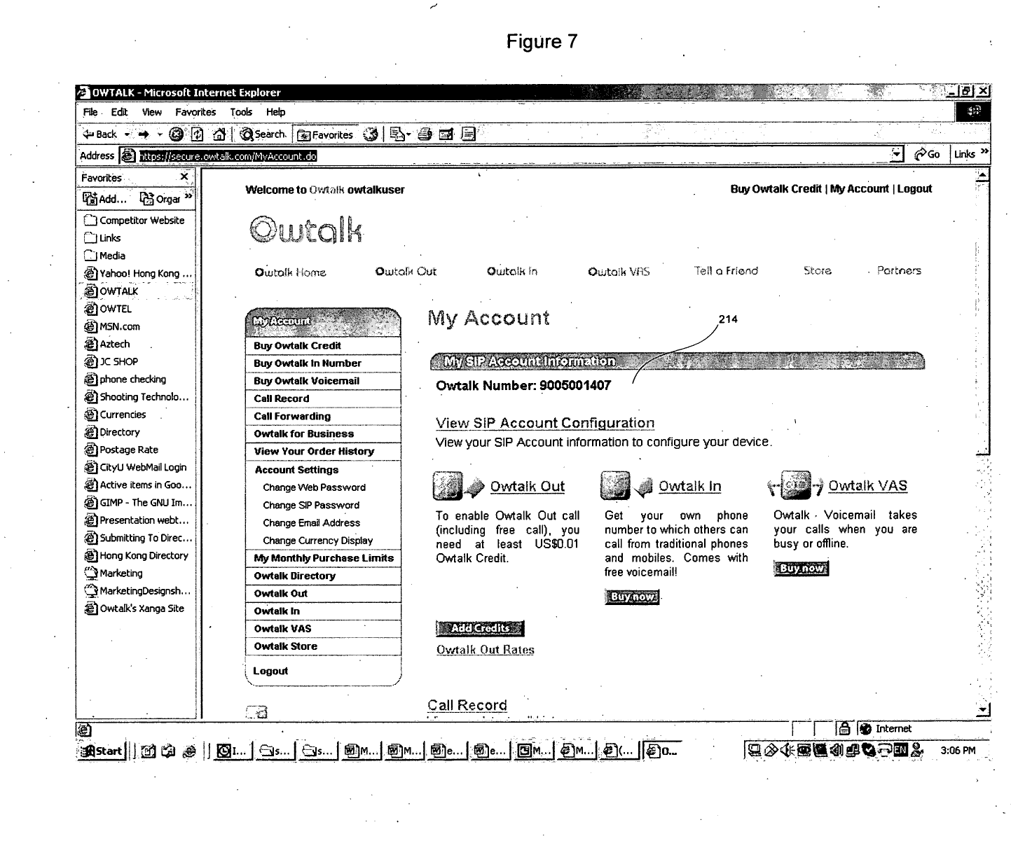

Referring to FIG. 7, the final web page shows the SIP number 215 of the device 40. The user may manage their account by clicking on the appropriate links on this web page to add more credit or add more functions such as voicemail, or modify their account settings.

The backend of the system is driven by a database 21. The database 21 centrally stores all the user accounts of the service provider 30, and the SIP numbers that have been allocated to those user accounts. The database has two main tables: web table and the asterisk table. The data fields of the two tables are:

Web Table—store SIP account information (name: SipAccount)

| Field name | Description |
|---|---|
| Custid | Customer number |
| Status | Authentication status (0 - not activated, |
| | 1 - activated, 2 - dirty) |
| SIP account | SIP account |
| SIP password | SIP password |

Web Table—store relationship between DNIS and custid (name: AuthDNIS)

| Field name | Description |
|---|---|
| DNIS | 00 + 7 digits random number |
| Custid | Customer number |
| Ts | Time Stamp |

Asterisk Table (name: sipprop)

| Field name | Description |
|---|---|
| Name | SIP account |
| Password | SIP password |
| Authkey | Same as DNIS in above table |
| Authflag | Flag to indicate whether authentication is |
| | completed |
| Authdt | Date time of authentication action |
| Aniflag | ani is activated (1 will not show ani, else will |
| | show) |
| Custid | Customer number of this SIP account |

The service provider 30 has an activation module 31 to respond to the activation number being dialed by the device 40. The activation module 31 processes the input of the activation number and modifies the two tables in the database 21. In one embodiment, the activation number is a DNIS number which is 00 plus 7 digits. If the device 40 is already activated, the process is terminated and the user is informed that activation is invalid. If the device 40 has not been activated, the authflag field of the asterisk table is retrieved by searching the asterisk table according to the activation number. If the authflag field is empty, the activation number is considered invalid and the user is informed. If the authflag field is equal to 0, the authentication process continues and the device 40 is activated. If not equal to 0, the activation number is considered invalid and the user is informed. The authentication process causes the web table to be updated and reflect that the device 40 has activated. The asterisk table is updated by storing the username, full name of the user and e-mail address against the activation number. The authflag and authkey data field in the asterisk table are also updated. Therefore, for the same data fields, the data is swapped between the web table and asterisk table. A background job is present that continually checks the SIP account with a dirty flag periodically. The background job re-generates the SIP password for the SIP account and resets the status to 0 for further usage.

Although it has been described that the Internet telephony hardware device 40 is a Voice over IP (VoIP) telephone, it may also be an Analog Telephone Adaptor (ATA).

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

What is claimed:

1. A method for activating an Internet telephony hardware device for use with a predetermined Internet telephony service provider, the Internet telephony hardware device being pre-configured with connection information for connecting to the predetermined Internet telephony service provider, the method comprising:
obtaining an activation number;
connecting the Internet telephony hardware device to the Internet; and
dialing the activation number using the Internet telephony hardware device to activate the Internet telephony hardware device for use with the predetermined Internet telephony service provider.

2. The method according to claim 1, further comprising performing a lookup on a database after the activation number is dialed, to match a Session Initiation Protocol (SIP) number of the Internet telephony hardware device with the activation number for authenticating the Internet telephony hardware device for use with the predetermined Internet telephony service provider.

3. The method according to claim 1, wherein the connection information comprises: SIP number, password, SIP proxy server address, port forwarding details, IP filters, IP address, subnet mask, local domain name, Virtual Private Network (VPN) pass-through, Point-to-Point Protocol over Ethernet (PPPoE) settings and Dynamic Host Configuration Protocol (DHCP) settings.

4. The method according to claim 1, further comprising the initial step of registering an account with the predetermined Internet telephony service provider to obtain the activation number.

5. The method according to claim 1, wherein the activation number is a Dialed Number Identification Service (DNIS) number.

6. The method according to claim 1, wherein the Internet telephony hardware device is a Voice over IP (VoIP) telephone or an Analog Telephone Adaptor (ATA).

7. The method according to claim 4, wherein registering with the predetermined Internet telephony service provider is performed via a web page.

8. The method according to claim 1, wherein each Internet telephony hardware device is pre-configured with connection information for the predetermined Internet telephony service provider by:
inputting connection information for a plurality of Internet telephony hardware device into an electronic file by the predetermined Internet telephony service provider;
providing the electronic file to another party; and
writing data including the connection information for each Internet telephony hardware device provided in the electronic file into firmware of each Internet telephony hardware device by the other party.

9. The method according to claim 8, further comprising incrementally reading the data from the electronic file for each Internet telephony hardware device by the other party, and automatically writing the data into firmware of each Internet telephony hardware device.

10. The method according to claim 8, wherein the writing of the data into firmware of each Internet telephony hardware device by the other party is performed by manual data entry.

11. The method according to claim 8, wherein the other party is a manufacturer of the Internet telephony hardware device.

12. A system for activating an Internet telephony hardware device for use with a predetermined Internet telephony service provider, the Internet telephony hardware device being pre-configured with connection information for connecting to the predetermined Internet telephony service provider, the system comprising:
an activation module to obtain an activation number; and
a dial pad provided by the Internet telephony hardware device to dial the activation number when the Internet telephony hardware device is connected to the Internet to activate the Internet telephony hardware device for use with the predetermined. Internet telephony service provider.

13. An Internet telephony hardware device, the device comprising:
pre-configured connection information for connecting to a predetermined Internet telephony service provider;
wherein an activation number is dialed by the Internet telephony hardware device to activate the Internet telephony hardware device for use with the predetermined Internet telephony service provider.

14. The device according to claim 13, wherein the pre-configured connection information comprises: SIP number, password, SIP proxy server address, port forwarding details, IP fitters, IP address, subnet mask, local domain name, Virtual Private Network (VPN) pass-through, Point-to-Point Protocol over Ethernet (PPPoE) settings and Dynamic Host Configuration Protocol (DHCP) settings.
